(19) United States
(12) Patent Application Publication
(10) Pub. No.: US 2024/0385918 A1
(43) Pub. Date: Nov. 21, 2024

(54) Adapting AIOps Models for Multi-Cloud Computing Systems

(71) Applicant: International Business Machines Corporation, Armonk, NY (US)

(72) Inventors: Saurabh Jha, White Plains, NY (US); Larisa Shwartz, Greenwich, CT (US); Frank Bagehorn, Dottikon (CH)

(21) Appl. No.: 18/198,492

(22) Filed: May 17, 2023

(51) Int. Cl. G06F 11/07; G06F 9/50

(52) U.S. Cl. CPC G06F 11/0709; G06F 9/5038; G06F 9/5072

(57) ABSTRACT

Mechanisms are provided for migrating an application to a new cloud computing system. A causal model is generated based on configuration parameters for a first cloud computing system, monitoring data collected for an execution of the application in the first cloud computing system, and an inserted causal layer. Chaos engineering logic is executed on the causal model to perform a fault injection on the configuration parameters to emulate a second cloud computing system configuration. A mapping, by the causal layer, of the configuration parameters to the monitoring data is learned based on the fault injection. An artificial intelligence for information technology operations (AIOps) model is updated, based on the learned mapping of the causal layer, for monitoring the application execution in the new cloud computing system. The updated AIOps model is provided to an observability tool executing on the new cloud computing system.

### BACKGROUND

The present application relates generally to an improved data processing apparatus and method and more specifically to an improved computing tool and improved computing tool operations/functionality for adapting artificial intelligence for information technology operations (AIOps) models for multi-cloud computing systems.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Cloud computing systems provide on-demand self-service, broad network access, resource pooling, rapid elasticity, and measures service. Cloud computing systems facilitate service models, such as Software as a Service (SaaS), Platform as a Service (PaaS), and Infrastructure as a Service (IaaS). Cloud computing systems further facilitated deployment models such as private clouds, public clouds, community clouds, and hybrid clouds.

Increasingly, applications, and their workloads, are becoming more multi-cloud, i.e., the services, infrastructure, platforms, etc., from a plurality of cloud computing systems are utilized to process these workloads. The reasons for this are varied and include users tending to use multiple cloud providers for high resiliency or availability, customers migrating jobs from one cloud provider to another for better performance or reduced costs, and customers wanting to avoid vendor (cloud provider) lock-in, i.e., customization of workloads resulting required use of a specific vendor's services/resources.

Multi-cloud computing requires that the applications and/or workloads be able to migrate across cloud providers. However, migrating such applications and/or workloads transparently is challenging as mission-critical (and user) applications/workloads depend on various AIOps models for resilient, secure, and performant operations. These AIOps models do not inter-operate across different cloud providers in a multi-cloud computing system because of inherent differences in the cloud provider architectures and performance, leading to differences in the distribution of observability data that are used to train the AIOps models.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for migrating an application to a new cloud computing system. The method comprises generating a causal model based on configuration parameters for a first cloud computing system, monitoring data collected for an execution of the application in the first cloud computing system, and an inserted causal layer. The method also comprises executing chaos engineering logic on the causal model to perform a fault injection on the configuration parameters to emulate at least one second cloud computing system configuration. The method further comprises learning a mapping, by the causal layer, of the configuration parameters to the monitoring data based on the fault injection by the chaos engineering logic. In addition, the method comprises updating an artificial intelligence for information technology operations (AIOps) model, based on the learned mapping of the causal layer, to be an updated AIOps model for monitoring the application execution in the new cloud computing system. Moreover, the method comprises providing the updated AIOps model to an observability tool executing on the new cloud computing system for use in monitoring the performance of the application in the new cloud computing system.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example diagram of a migration of an application from one cloud provider to another cloud provider;

FIG. 3 is an example diagram illustrating an example interaction between a multi-cloud controller, an observability tool, and an artificial intelligence for information technology operations (AIOps) model adaptation system in accordance with one illustrative embodiment;

FIG. 4 is an example diagram illustrating a mapping from one cloud provider to another cloud provider in accordance with one illustrative embodiment;

FIG. 5 is an example diagram illustrating an offline phase of operation of an AIOps model adaptation system in accordance with one illustrative embodiment;

FIG. 6 is an example diagram illustrating an online phase of operation of an AIOps model adaptation system in accordance with one illustrative embodiment;

FIG. 7 is a flowchart outlining an example offline operation of an AIOps model adaptation system in accordance with one illustrative embodiment; and

FIG. 8 is a flowchart outlining an example online operation of an AIOps model adaptation system in accordance with one illustrative embodiment.

### DETAILED DESCRIPTION

The illustrative embodiments provide an improved computing tool and improved computing tool functionality/operations that create artificial intelligence for information technology operations (AIOps) models for multi-cloud computing systems. The mechanisms of the illustrative embodiments build AIOps models that are transferrable across multiple cloud providers in an immediate and transparent inter-operable manner, where these AIOps operate to ensure service level objective (SLO) violation detection, diagnosis, and mitigation. The illustrative embodiments introduce a causal layer between the cloud provider and the monitoring data. In some illustrative embodiments learn a causal model by learning the inter-dependence between the cloud provider and the monitoring data using chaos engineering.

The use of chaos engineering and causal methods (but not limited to causal methods only) enables AIOps model inter-operability across cloud providers, or cloud computing systems of cloud providers, without having to use fault injections for each cloud provider/cloud computing system, or run applications/workloads on each cloud provider/cloud computing system, to learn how the application/workload behavior will change from one cloud provider/cloud computing system to another. The use of chaos engineering and causal methods to enable AIOps model inter-operability eliminates the need to migrate the AIOps model and reduces the time to adapt the AIOps model as there is no need to implement tools to build cloud provider/cloud computing system specific fault injectors. The use of chaos engineering and causal methods to enable AIOps model inter-operability reduces the costs of data collection and training such AIOps models as well.

As the illustrative embodiments are specifically directed to improving computing technology and computing tool functionality/operations with regard to AIOps models and multi-cloud computing systems, it is beneficial to have an understanding of AIOps before proceeding to the discussion of the improvements provided by the improved computing tool and improved computing tool functionality/operations of the illustrative embodiments. AIOps is the application of artificial intelligence (AI) mechanisms, such as natural language processing, machine learning models, various computer assisted decision support systems, and the like, to automate and streamline information technology (IT) operational workflows. AIOps uses big data, analytics, artificial intelligence and machine learning capabilities to do the following:
(1) collect and aggregate the huge and ever-increasing volumes of data generated by multiple IT infrastructure components, application demands, and performance monitoring tools, and service ticketing systems;
(2) intelligently sift “signals” out of the “noise” to identify significant events and patterns related to application performance and availability issues; and
(3) diagnose root causes and report them to IT and DevOps for rapid response and remediation or, in some cases, automatically resolve these issues without human intervention.

By integrating multiple separate IT operations tools into a single, intelligent, and automated IT operations platform, AIOps enables IT operations teams to respond more quickly, and even proactively, to performance degradation and outages, with end-to-end visibility and context AIOps bridges the gap between an increasingly diverse, dynamic, and difficult-to-monitor IT landscape as well as bridges siloed development and operations teams, on the one hand, and user expectations for little or no interruption in application performance and availability, on the other. AIOps uses a big data platform to aggregate siloed IT operations data, teams, and tools in one place, where this data can include historical performance and event data, streaming real-time operations events, system logs and metrics, network data including packet data, incident-related data and ticketing, application demand data, and infrastructure data, for example. AIOps applies focused analytics and machine learning capabilities to this data to separate significant event alerts from the “noise”, identify root causes and propose solutions, automate response including real-time proactive resolutions, and continually learn to improve handling of future problems.

AIOps provide various features to an organization's IT systems including, but not limited to, observability, predictive analytics, and proactive response. Observability refers to software tools and practices for ingesting, aggregating, and analyzing a steady stream of performance data from a distributed application and the hardware it runs on, in order to more effectively monitor, troubleshoot and debug the application to meet customer experience expectations, service level agreements (SLAs), service level objectives (SLOs), and other business requirements. AIOps solutions can give a holistic view across an organization's applications, infrastructure, and network through data aggregation and consolidation AIOps solutions collect and aggregate IT data from a variety of data sources across IT domains to alert end users of potential issues, enabling IT service teams to implement the necessary remediation.

With regard to predictive analytics, AIOps solutions can analyze and correlate data for better insights and automated actions, allowing IT teams to maintain control over the increasingly complex IT environments and assure application performance. Being able to correlate and isolate issues is a massive step forward for any IT Operations team. AIOps solutions reduce the time to detect issues that might not have otherwise been found in the organization. As a result, organizations reap the benefits of automatic anomaly detection, proactive and reactive alerting and solution recommendations, which in turn reduces overall downtime as well as the number of incidents and tickets. Dynamic resource optimization can be automated using predictive analytics, which can assure application performance while safely reducing resource costs even during high variability of demand.

With regard to proactive response, some AIOps solutions will proactively respond to unintended events, such as performance degradation and outages, bringing application performance and resource management together in real-time By feeding application metrics into predictive algorithms, they can identify patterns and trends that coincide with different IT issues With the ability to forecast IT problems before they occur. AIOps tools can launch relevant, automated processes in response and rectify issues quickly. As a result, organizations will be able to see improved mean time to detection (MTTD).

The overarching benefit of AIOps is that it enables IT operations to identify, address, and resolve slow-downs and outages faster than they can by sifting manually through alerts from multiple IT operations tools, and in situations where the volume of data makes such manual operations not practical. This results in several key benefits such as faster mean time to resolution (MTTR), lower operational costs, more observability and better collaboration.

As noted previously, while AIOps tools provide a great benefit to IT systems and IT management, especially in cloud computing systems that may involve complex interactions between applications when leveraging the offerings of services, infrastructure, platforms and the like from cloud providers, the limitations of AIOps tools being trained and configured to the particular cloud provider's offerings is a significant issue as applications and/or workloads increasingly utilize multi-cloud implementations. That is, as noted above, multi-cloud implementation of applications/workloads requires the ability to migrate the application/workload across cloud providers and continue providing uninterrupted observability and operations, which currently is not adequately enabled given that applications/workloads rely on AIOps tools for resilient, secure, and performant operations and such AIOps tools are not trained and configured in a manner that they can be easily adapted from one cloud provider to another without retraining and fine tuning on new datasets.

That is, if an AIOps model is to be transferred from one cloud provider to another, i.e., adapt the AIOps model to a different cloud provider/cloud computing system, the AIOps model would require retraining and fine-tuning of the AIOps model with a new dataset which must be obtained from the cloud provider/cloud computing system to which the application/workload is to be migrated. There are two ways that the new dataset may be obtained: waiting, after migration of the application to the new cloud provider system, for faults or performance anomalies to create a historical dataset, or injecting faults into the input data and collecting the dataset under different fault conditions. That is, when an application broker moves an application and/or application workload (hereafter referred to as an application for simplicity) from one cloud provider to another, there is no historical data at the new cloud provider to use to train the AIOps models for the new environment at the new cloud provider. Thus, there is a time period in which the AIOps model will not be able to accurately monitor and mitigate SLA/SLO violations, as it will be trained to operate assuming the previous cloud provider environment. Moreover, if one uses fault injection to generate the new dataset to retrain the AIOps model, again such fault injection can be time consuming and costly and has a similar time period in which the AIOps model cannot accurately monitor and mitigate the SLA/SLO violations while being retrained for the new cloud provider environment based on the collected data from the various injected faults.

With the mechanisms of the illustrative embodiments, however, during an offline operation, a causal model is generated and chaos engineering is used to learn the parameters of the causal model using multi-intervention fault injections. The multi-intervention fault injections mimic various cloud providers that an application broker or end user can access. Based on the causal model in some illustrative embodiments, the causal model may be used as a causal generative model (CGM) to generate a training dataset from existing historical data of the new cloud provider/cloud computing system, and then retrain the AIOps model, such that an updated AIOps model for the new cloud provider is generated that is a fine-tuned version of the original AIOps model. This illustrative embodiment may be implemented in situations where retraining time is acceptable to the party relying on the application/workload. In some illustrative embodiments, such as where retraining time is prohibitive, the causal model may be used to provide an embedding layer for the AIOps model that is fine-tuned based on the causal model, such that the updated AIOps model is a combination of the original AIOps model and the fine-tuned embedding layer.

During online operation, the mechanisms of the illustrative embodiments involve performing an inference operation based on what was done during the offline phase to generate the updated AIOps model. That is, during an online phase, the application broker triggers the application migration from one cloud provider to another, which in turn triggers the mechanisms of the illustrative embodiments. Depending on the steps followed in the offline phase, i.e., which illustrative embodiment was implemented based on whether retraining of the AIOps model was performed or not, the inference performed during online operation may either use the monitoring data collected during the online phase for input to the updated AIOps model that was retrained during the offline phase, or may use the monitoring data during the online phase as input to the embedding layer which then provides input to the AIOps model for performing inference operations. It should be noted that in both cases, the application does not need to be relaunched on a new cloud provider to adapt the AIOps model, which saves on time, resources, and costs for migration of the application from one cloud provider to another.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides an AIOps model adaptation system that operates to adapt an AIOps model associated with operations/observability of an application that is migrated from one cloud computing system/cloud provider to another. The improved computing tool implements mechanism and functionality which cannot be practically performed by human beings either outside of, or with the assistance of, a technical environment, such as a mental process or the like. The improved computing tool provides a practical application of the methodology at least in that the improved computing tool is able to adapt AIOps models to new cloud computing systems/cloud providers so that they can continue to function and generate accurate predictions even when the configuration of the infrastructure on which the application executes is modified.

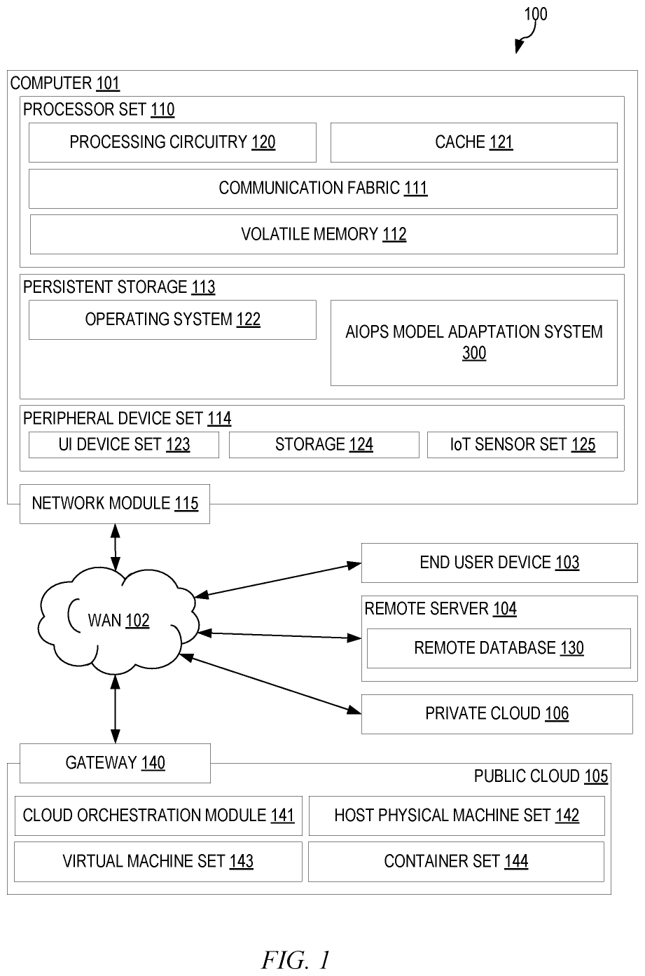

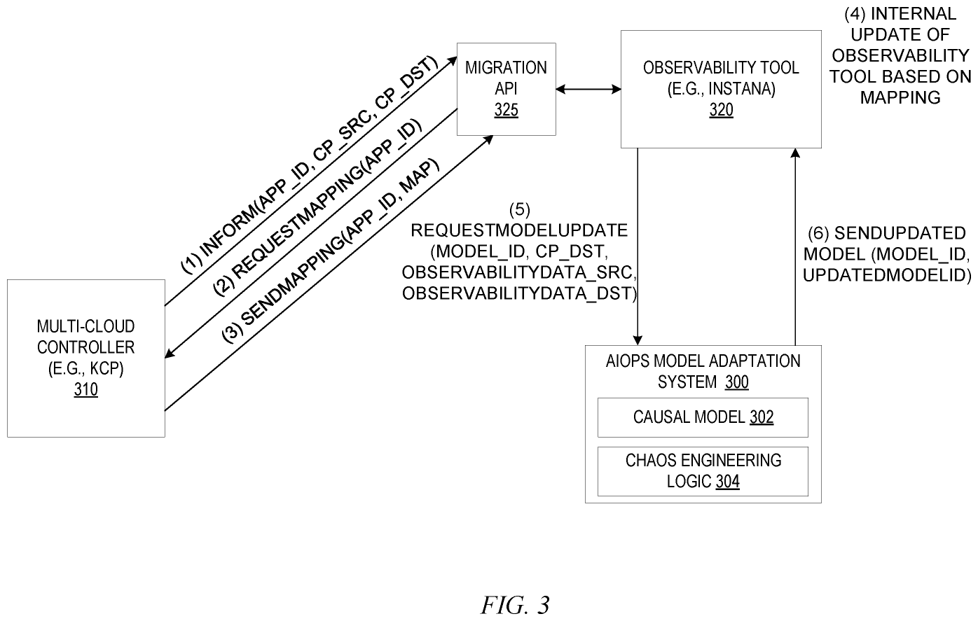

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as AIOps model adaptation system 300 in FIG. 3, as discussed hereafter. In addition to block 300, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement an AIOps model adaptation system 300. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computing device 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates transparent migration of applications and adaptation of corresponding AIOps models for monitoring and managing multi-cloud applications across cloud providers, making multi-cloud applications less costly in terms of time and resources to implement.

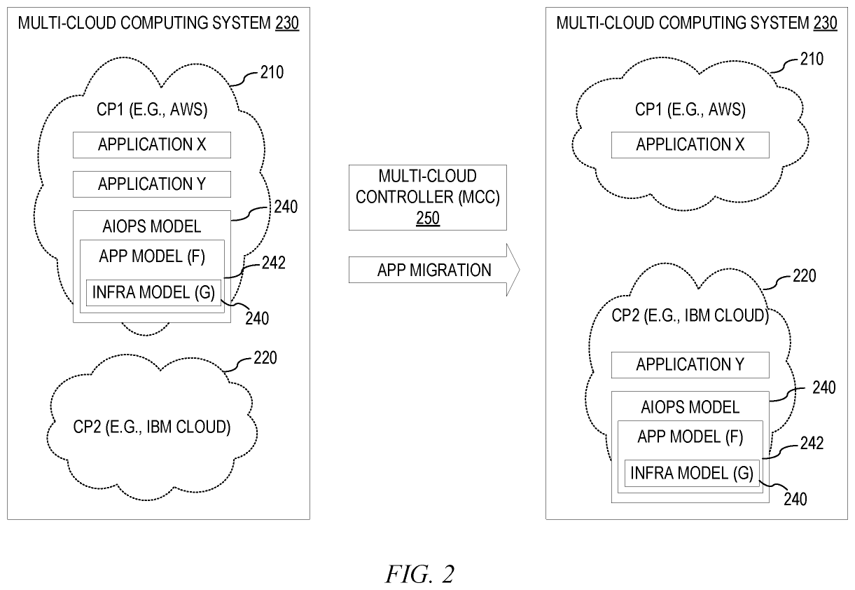

The AIOps model adaptation system 300 operates to facilitate the migration of applications/workloads from one cloud provider to another while adapting the AIOps models that are used to ensure resilient, secure, and performant operation of these applications/workloads in a transparent and timely manner that minimizes costs in time and resources. To better understand the situation in which the AIOps model adaptation system 300 is implemented, consider the example shown in FIG. 2.

FIG. 2 is an example diagram of a migration of an application from one cloud provider to another cloud provider (CP), i.e., from CP1 to CP2. The cloud providers themselves may be any current or later implemented cloud provider system. Examples of cloud providers include IBM Cloud available from International Business Machines Corporation of Armonk, New York, Amazon Web Services® (AWS) available from Amazon.com, Inc. of Seattle, Washington, Microsoft Azure® available from Microsoft Corporation of Redmond, Washington, Google Cloud® available from Alphabet, Inc. of Mountain View, California, and the like.

In the depicted example of FIG. 2, an application Y is to be migrated from the first cloud provider 210 to the second cloud provider 220 of a multi-cloud computing (MCC) system 230. In the depicted example, the applications X and Y are implemented initially on an AWS cloud computing system 210 and are to be migrated to the IBM Cloud computing system 220. The application Y has a corresponding AIOps model 240 which is built upon a model of the application, i.e., application model 242, and a model of the infrastructure of the cloud computing system 210, i.e., infrastructure model 244. Thus, the AIOps model 240 is specific to the particular instance of the application in the cloud computing system 210 and the infrastructure of that cloud computing system 210 from the first cloud provider CP1, e.g., AWS®.

Assume then that an event causes a need to migrate the application Y to the second cloud computing system 220 from cloud provider CP2, e.g., IBM Cloud. For example, a server outage in the first cloud computing system 210, a user request to move the application to the second cloud computing system 220, an automated multi-cloud controller (MCC) 250, or application broker, determining that a cost savings may be achieved by migrating the application Y, or the like, may be events that cause the initiation of a migration operation to migrate the application Y to the second cloud computing system 220. There may be many different reasons why the MCC 150 may determine that a migration of an application Y from one cloud provider's cloud computing system to another would be beneficial to the organization(s) using the application Y. One example of a MCC 250 that may be used to make such determinations is Kubernetes Control Plane (KCP) which is part of Red Hat® Cloud Services available from Red Hat, Inc. of Raleigh, North Carolina. Of course, other MCCs or application brokers that can make automated migration determinations for applications may be used without departing from the spirit and scope of the present invention.

While the application Y and its already trained AIOps model 240 may be migrated to the second cloud computing system 220 as shown on the right hand side of FIG. 2, the AIOps model 240 will not be accurate as it assumes that application model parameters and infrastructure parameters for the original cloud computing system 210, i.e., the AIOps model 240 assumes that it is still collecting monitoring data and generating predictions/classifications of performance, faults, and the like, in the first cloud computing system 210 assuming the same application parameters and infrastructure of the first cloud computing system 210. Thus, this may lead to incorrect performance monitoring, false alarms, and/or undetected faults with regard to SLA/SLO violations, and the like. This may lead to significant issues with regard to the resiliency, security, and performance of the application Y after migration to the second cloud computing system 220.

Thus, in order to ensure accurate operation of the AIOps model 240 in the new cloud computing environment 220, the AIOps model 240 needs to be retrained with training data collected from the second cloud computing system 210 using the infrastructure and application configuration parameters of the second cloud computing system 210. However, it may take days of operation to collect the necessary amount of monitoring data to retrain the AIOps model 240 to take into account the particular application parameters and infrastructure parameters of the application executing in the second cloud computing system 220 of the second cloud provider (CP2). That is, the AIOps model 240 still needs to be able to function accurately regardless of where the application Y is located, i.e., in the first cloud computing system 210 from the first cloud provider (CP1) or the second cloud computing system 220 from the second cloud provider (CP2). The time for retraining, and the potentially inaccurate operation of the AIOps model 240 during that time period, makes retraining using monitoring data collected for the application Y after migration not a feasible option, as the organization relying on the application Y cannot fully rely on the application until the AIOps model 240 is retrained and known to be operating correctly in the new cloud computing system 220.

One method for addressing these issues may be to deploy the application Y to each of the possible cloud computing systems, executing the application in each of the cloud computing systems, and generating an AIOps model for each separate cloud computing system. However, such an approach requires a great deal of cost in terms of time and resources. Moreover, each time a new cloud computing system is added to the possible cloud computing systems, or there is a significant change to the cloud computing systems, these AIOps models would need to be retrained, which again results in many days of time and resource cost where the application may be operating outside of SLA/SLO requirements or faults/failures, performance slowdowns, etc., may not be accurately identified.

The illustrative embodiments provide mechanisms for generation of a causal model and for learning parameters of the causal model using chaos engineering, which allows AIOps models to be adapted to different cloud computing system infrastructures without requiring launching of the application in each possible cloud computing system, and with minimized time delay between migration and an accurately operating AIOps model that is updated to the new cloud computing environment. For example, rather than having to collect monitoring data over days of operation of the migrated application, the mechanisms of the illustrative embodiments leverage the knowledge of cloud computing system parameters, and variations in these parameters generated using multi-fault injection through chaos engineering, to provide a hidden embedding layer of a causal model that maps cloud computing parameters to monitoring data. With this causal model, the mechanisms of the illustrative embodiments only collect a few minutes of monitoring data to fine tune the hidden embedding layer of the causal model to the particular cloud computing system, resulting in a significant cost savings compared to the multiple days required to retrain an AIOps model, and further resulting in a more transparent migration and adaptation, from the viewpoint of the organization or customer relying on the application, of the application and its AIOps model from one cloud computing system to another.

FIG. 3 is an example diagram illustrating an example interaction between the primary operational components, including a multi-cloud controller (or application broker), an observability tool, and an artificial intelligence for information technology operations (AIOps) model adaptation system, in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., requests to migrate an application from one cloud provider to another, and the resulting output may aid human beings, e.g., the results of processing workloads via the migrated application. The invention is specifically directed to the automatically operating computer components directed to improving the way that multi-cloud applications are migrated from one cloud provider to another, specifically with regard to the AIOps models used to monitor and address performance issues that may arise with regard to service level agreements (SLAs) and/or service level objectives (SLOs). These mechanisms cannot be practically performed by human beings as a mental process and are not directed to organizing any human activity.

As shown in FIG. 3, the primary operational components include a multi-cloud controller (MCC) 310, an observability tool 320, and the AIOps model adaptation system 330 of the illustrative embodiments. The MCC and observability tool 320 may themselves be known or later developed tools. As noted previously, an example of a MCC 310 may be KCP. An example of the observability tool 320 may be IBM Istana®, available from International Business Machines Corporation of Armonk, New York, which monitors the operation of applications and reports monitoring data and generates observability visualizations for monitoring the performance of such applications for compliance with SLAs/SLOs.

In accordance with the illustrative embodiments, in addition to providing the AIOps model adaptation system 300, the illustrative embodiments further provide a migration API 325 that may be utilized by the MCC 310 to inform the observability tool 320 of the migration of applications from one cloud provider (CP1) cloud computing system to another cloud provider (CP2) cloud computing system, e.g., cloud computing system 210 to cloud computing system 220 in FIG. 2. The MCC 310 may inform the observability tool, via the API 325 that an application, identified by an application identifier (APP_ID), is being migrated from a source cloud provider (CP_src) to a destination cloud provider (CP_dst), such as via an Inform (APP_ID, CP_src, CP_dst) call to the API 325 (step 1). The CP_src represents the cloud computing system configuration prior to the migration of the application, while CP_dst represent the cloud computing system configuration after the migration of the application. This cloud computing system configuration information may include the cloud provider name, instance type, OS image, network configuration, storage configuration, and other parameters representing the configuration of the infrastructure of the cloud computing system.

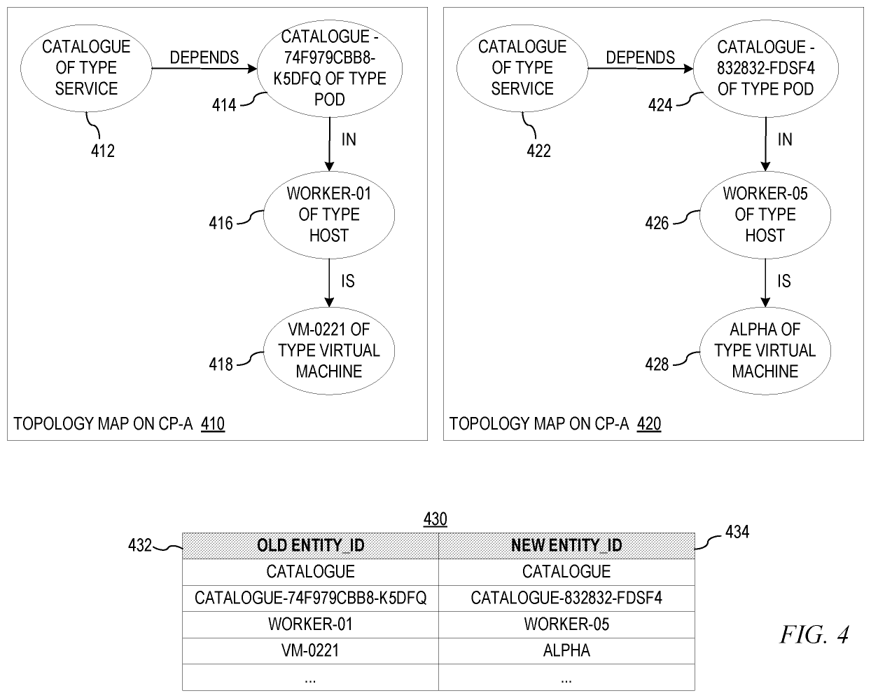

As a result of the Inform (APP_ID, CP_src, CP_dst) call to the API 325, the observability tool 320 responds with a request for a mapping data structure that maps the application instance information in the source cloud provider to the application instance information in the destination cloud provider (step 2). This is further described in greater detail hereafter with reference to FIG. 4. This mapping essentially maps elements of the infrastructure of the source cloud provider to similar infrastructure elements in the destination cloud provider, but which may have different names, parameters, and the like, in the destination cloud provider. This mapping is used to ensure that the observability tool 320 does not regard the application at the destination cloud provider to be a new application instance and instead is the same application instance, just in a new location at the destination cloud provider. The MCC 310 maintains such mappings from the transformation, and provides the corresponding mapping to the observability tool 320, e.g., as a response of the type SendMapping (App_ID, map) where map is the mapping data structure that maps entities in the source cloud computing system infrastructure to entities in the destination cloud provider computing system infrastructure (step 3). It should be noted that the terms “cloud computing system” and “cloud provider” may be used interchangeably at times herein to refer to the cloud computing system, but in actuality the cloud provider is the entity providing the cloud computing system and may in fact provide multiple different cloud computing systems of various configurations.

Based on the mapping data structure, the observability tool 320 updates its internal references of the entities in the cloud computing system topology to be the new entities referenced in the mapping data structure (step 4). For example, a catalogue pod in Kubernetes in a first cloud computing system may have an entityID of X, but after moving the application to the second cloud computing system, the entityID of the catalogue pod may be Y. The internal update allows the observability tool 320 to recognize that the newly discovered application on the second cloud computing system is in fact the same application that was executing in the first cloud computing system.

The observability tool 320 sends a request to the AIOps model adaptation system 300 to request that the AIOps model be updated for the new infrastructure of the new (destination) cloud provider, e.g., by sending a RequestModelUpdate (Model ID, CP_dst, ObservabilityData_src, ObervabilityData_dst) request to the AIOps model adaptation system 300 (step 5). The ObservabilityData_src is a reference to the training data used to train the AIOps model for the source cloud computing system and is provided in case a retraining is possible, as discussed herein. The ObservabilityData_dst sent by the observability tool 320 is a few minutes of monitoring data collected by the observability tool 320 after migration of the application to the destination cloud computing system. This monitoring data is significantly smaller than the much larger ObservabilityData_src that was used to train the AIOps model for the source cloud computing system, which may be multiple days of monitoring data. The Model_ID is a unique identifier of the AIOps model that is to be updated. The CP_dst are the configuration parameters for the destination cloud computing system, as previously mentioned above.

Thus, the request provides the necessary information to update the AIOps model specified by the Model_ID for the configuration of the infrastructure of the destination cloud computing system using the causal model 302 and chaos engineering logic 304 generated causal model parameters, as will be discussed in greater detail hereafter. The AIOps model adaptation system 300 operates to update the AIOps model for the new (second) cloud computing system and sends the updated AIOps model to the observability tool 320 for use in monitoring the performance of the migrated application in the new (second) cloud computing system (step 6). Notably, this process minimizes any inaccurate operation of the AIOps model to only the time to obtain a minimal set of monitoring data, e.g., only a few minutes, rather than days, resulting in more accurate performance of the AIOps model and less cost for performing the migration of the application and adaptation of its AIOps model from one cloud provider's cloud computing system to another cloud provider's cloud computing system.

As mentioned previously, in order for the observability tool 320 to know that the application that has been migrated to the new cloud computing system is in fact the same application that was present in the first cloud computing system, a mapping data structure is used to map entities from the first cloud computing system to the second cloud computing system, or first and second cloud providers. FIG. 4 is an example diagram illustrating a mapping from one cloud provider to another cloud provider in accordance with one illustrative embodiment. As shown in FIG. 4, an example first cloud computing system topology 410 is shown for a first cloud provider (CP-A) and an example second cloud computing system topology 420 is shown for a second cloud provider (CP-B). In the first topology 410, a catalog service 412 depends on a catalogue pod 414. It should be appreciated that the examples assume a Kubernetes platform, but the illustrative embodiments are not limited to such, and nay suitable platform for the particular implementation may be used without departing from the spirit and scope of the present invention. Assuming a Kubernetes platform as an example, the “pod” is an encapsulation of one or more applications, which may include one or more containers, such as Docker containers or the like. Pods allow the Kubernetes platform to automatically create replicas of the pod to continue operations should a pod, or the node it executes on, fail.

The catalog pod 414 executes on a host 416. The host 416 is implemented as a virtual machine 418. Thus, a topology 410 comprises the topology graph 410 having nodes 412-418 and the edges connecting and representing the dependencies and relationships between these nodes. This topology 410 represents the infrastructure of the source (first) cloud computing system in which the application, i.e., the catalogue service, was originally executing. A similar topology 420 is shown for the destination cloud computing system after migration of the application 412 to the destination cloud computing system, with the migrated application being element 422, but being the same application and not a new application instance. As shown in the topology 420 for the second cloud computing system of cloud provider CP-B, the catalogue service application 422 depends on a different catalogue pod 424, which in turn is executed in a different host 426 and virtual machine 428.

Thus, one can see from a comparison of the topologies 410 and 420, that when migrating the application 412 to the new cloud computing system as application 422, some things in the way that the application 422 executes in the new cloud computing system change from the way that the application 412 executed in the source cloud computing system. These changes in the infrastructure will cause differences in configuration of the cloud computing system and differences in monitoring data that is collected.

A mapping data structure 430 is generated to map entities from the source cloud computing system topology 410 to corresponding entities in the destination cloud computing system topology 420. The mapping data structure 430 has a first set of entries 432 representing the “old” entities in the source cloud computing system topology 410 and a second set of entries 434 representing the “new” entities in the new cloud computing system topology 420 to which the old entities are mapped, e.g., “catalogue-74f979cbb8-k5dfq” maps to “catalogue-832832-fdsf4”, Worker-01 maps to Worker-05, and VM-0221 maps to Alpha. Thus, for each entity in the application and system topology, the MCC 310 provides a map as tuples in the form of <Old EntityID, New EntityID> thereby defining a mapping data structure 430.

Based on these tuples in the mapping data structure 430, the observability tool 320 internally updates the references to the entities of the system and application topology the observability tool 320 uses to monitor the performance of the application and collect monitoring data. The observability tool 320 then requests a model update from the AIOps model adaptation system 300, sending the destination configuration of the cloud computing system, indicated by the updated topology entities updated by the observability tool 320, and a few minutes of observability data, i.e., monitoring data, collected by the observability tool 320. The observability tool 320 then receives the updated AIOps model from the AIOps model adaptation system 300.

This request to update the AIOps model is generated and sent to the AIOps model adaptation system 300 during an online or runtime phase of operation. However, the way in which the AIOps model adaptation system 300 generates the updated AIOps model is dependent upon its offline phase operation as well. Thus, the following description will first describe the offline phase of operation of the AIOps model adaptation system 300 followed by the online phase of operation, which may respond to requests from the observability tool 320 to update the AIOps model in response to migration of an application from one cloud computing system of a first cloud provider to a second cloud computing system of a second cloud provider.

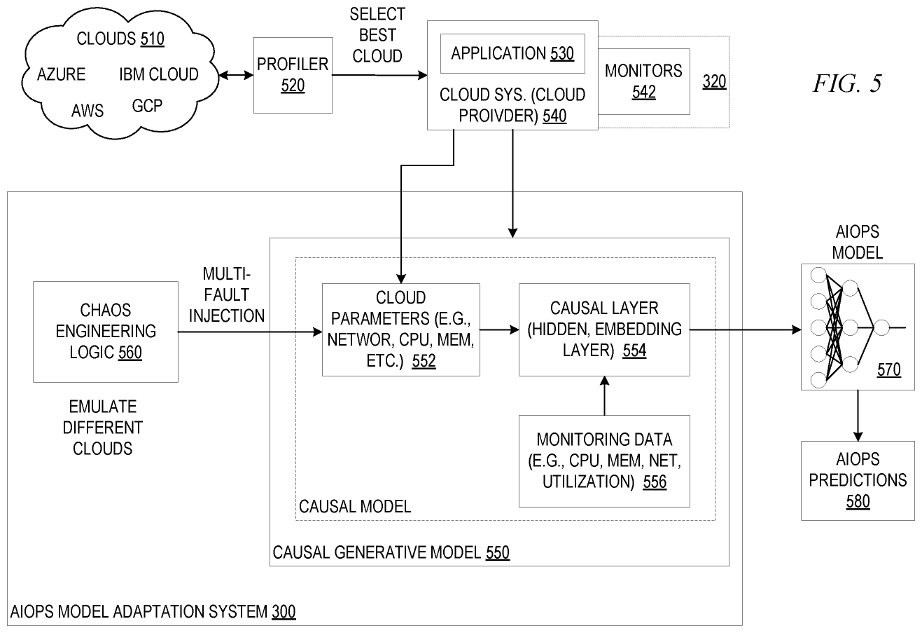

FIG. 5 is an example diagram illustrating an offline phase of operation of an AIOps model adaptation system in accordance with one illustrative embodiment. During the offline phase of operation, a profiler 520 operates to profile a plurality of cloud computing systems/cloud providers 510. These cloud computing systems and cloud providers do not change often, so the profiling is essentially a one-time overhead that collects configuration parameter information for each of these cloud computing systems/cloud providers without running the application on these cloud computing systems/cloud providers. The profiler 520 comprises a set of benchmarking tools, such as stress-ng, NCCL, Google PerfKit Benchmarker, or the like, which collects the benchmark data representative of the performance and configuration of the various cloud computing systems/cloud providers 510.

From the profiles of the cloud computing systems/cloud providers, the best performing cloud computing system/cloud provider is selected to execute the application. Here, “best” is determined against a predetermine set of criteria prioritizing different benchmarks. For example, in some illustrative embodiments, given extensive virtualization of cloud systems, parameters such as CPU, memory, and the like, are additive and thus, a Max for each parameter over all cloud computing systems may be defined in the dataset and the “best” cloud computing system based on these Max values may be requested and selected. The application 530 is then launched on the selected cloud computing system/cloud provider 540 and its execution is monitored by monitors 542 of an observability tool to generate monitoring data 556, e.g., memory, cpu, network utilization, and other performance measures.

The AIOps model adaptation system 300 knows the configuration parameters of the cloud computing system/cloud provider 552 from the profiler 520, e.g., network configuration data, cpu configuration data, memory configuration data, etc. This configuration data is an indication of how the cloud computing system/cloud provider performs when executing applications/workloads in general and serves as a baseline. The AIOps model adaptation system 300 further receives the monitoring data 556 from the monitors 542 of the observability tool monitoring the execution of the application 530 on the selected cloud computing system/cloud provider 540.

The cloud computing system/cloud provider configuration parameters 552, monitoring data 556, and a causal layer 554, also referred to as a hidden or embedding layer, are used to create a causal generative model 550. The causal generative model 550 may be a causal generative neural network computer model which learns a functional causal model from generative neural networks where these networks are trained through backpropagation to minimize the maximum mean discrepancy to the observed data. CGNNs do not only estimate the causal structure, but a full and differentiable generative model of the data. CGNNs are generally known in the art. The illustrative embodiments implement such a CGNN 550 to learn a functional causal model, through the use of the causal layer 554, that maps the cloud computing system/cloud provider configuration parameters 552 with the monitoring data 556 for an application 530 executing in a cloud computing system/cloud provider having the configuration parameters 552.

In order to learn the mapping of the causal layer 554, the AIOps model adaptation system 300 uses chaos engineering logic 560 to perform multi-fault injection into the configuration data 552 to emulate various cloud computing systems/cloud providers that may execute the application 530. It should be noted that the chaos engineering logic 560 performs multi-fault injection, rather than single fault injection, to represent a modification of the configuration of the cloud computing system/cloud provider with regard to each node in the cloud computing system. With each multi-fault injection, a new cloud computing system/cloud provider configuration is modeled via the perturbed configuration parameters 552, thereby emulating the cloud computing system operating as if it has these perturbed configuration parameters 552. Thus, with chaos engineering and the multi-fault injection parameters of other cloud computing systems are mimicked while not requiring a reconfiguration of the system. That is, the system behaves like one of the other clouds due to the perturbed configuration parameters 552. For example, if the configuration parameter for the memory size is perturbed to be less than the selected “best” cloud computing system, a workload may be deployed that would occupy memory to the point that memory available to the application in question is similar to what other cloud computing systems offer and thereby emulate the more limited memory resources.

Thus, the AIOps model adaptation system 300 learns a causal graph and causal graph parameters for mapping configuration parameters to monitoring data by first constructing a causal graph by learning the system parameters that help characterize cloud computing systems/cloud provider system infrastructure and its performance using the profiling results obtained from the profiler 520 and domain knowledge. The cloud computing system/cloud provider configuration parameters 552 are represented as infra nodes. In addition, all the monitored datasets 556 are identified with each monitored dataset being represented as monitoring nodes in the causal graph. The relationships between the monitoring nodes and the infra nodes are then identified to generate a graph G. A hidden state node (H), of the causal layer 554, is inserted for each monitoring node. The hidden state node H is connected in the causal graph to the monitoring node, and infra nodes are connected to H for each edge going from the infra node to the monitoring node in G, to thereby generate the causal graph G′. The parameters of the causal graph G′ are then learned using the multi-fault injections of the chaos engineering logic 560. For example, a first multi-fault injection may mimic a first cloud computing system of a cloud provider (CP-A) which has 10 gbs network and 2.4 Ghz CPU on a cloud computing system of cloud provider (CP-B) which has 25 gbps network and 3.2 Ghz CPU by injecting faults that (a) reduces the network bandwidth, and (b) throttles the CPU of CP-B, where in this example, CP-B is the “best” cloud computing system/cloud provider or most powerful, i.e., having the most available resources.

With each different configuration 552 generated as a result of multi-fault injection by the chaos engineering logic 560, different monitoring data 556 is obtained from the monitors 542 monitoring performance of the application 530 on the reconfigured cloud computing system/cloud provider 540 using the perturbed configuration parameters 552. The causal generative model 550 learns an updated mapping of the causal layer 554 from the perturbed cloud computing system/cloud provider configuration parameters 552 to the monitoring data 556 for that configuration, e.g., learns a new node H for the infra nodes and monitoring nodes. Thus, over multiple different multi-fault injections by the chaos engineering logic 560, the causal layer 554 learns mapping parameters to map cloud computing system/cloud provider configuration parameters to monitoring data for the application executing in a cloud computing system having those configuration parameters.

That is, the causal layer 554 may output modified monitoring data, which is a modified form of the monitoring data 556, that represents the monitoring data that would be generated from the application executing in a cloud computing system having the specified configuration parameters 552. In this way, the causal layer 554 may be given an input set of configuration parameters 552 and monitoring data 556, and can modify the monitoring data 556 so that it is adjusted for the configuration parameters 552. The resulting updated monitoring data is output to the AIOps model 570 which was trained for a different cloud computing system/cloud provider.

It should be appreciated that the output from the causal layer 554 may be implemented to update the AIOps model 570 in different ways depending on whether the costs of retraining the AIOps model 570 are acceptable to the organization/customer relying on the application 530, or not. In a case where retraining costs are not prohibitive, the causal model G′ learned by way of the causal generative model, causal layer, and chaos engineering logic, may be used as a causal generative model to generate training data for a new cloud computing system or cloud provider using existing historical monitoring datasets for the new cloud computing system. That is, in FIG. 5, rather than monitoring data from execution of the application in the cloud computing system, after the learning of the causal model and mapping in the causal layer 554, the monitoring data 556 may in fact be replaced with already existing historical data for the new cloud computing system/cloud provider. The existing historical data is fed into the causal layer 554 along with the configuration parameters 552 for the new cloud computing system/cloud provider, and the resulting modified training dataset is output to the AIOps model 570 for training the AIOps model 570. In this case, the causal layer 554 emulates the application 530 executing on the new cloud computing system/cloud provider having the configuration parameters 552, using the historical existing data as an estimate of the data that may be generated from monitors 542 of the observability tool. This estimated data is modified to represent the application 530 generating monitoring data, to thereby emulate the application 530 executing in the cloud computing system/cloud provider. This emulated monitoring data may then be input to the AIOps model 570 to retrain the AIOps model 570 for evaluating the application 530 executing in the new cloud computing system/cloud provider and generating accurate predictions 580.

This retraining can be done during an offline stage prior to migration of the application to the new cloud computing system/cloud provider and does not require that the application actually be launched in the new cloud computing system/cloud provider. To the contrary, all that is required is that the configuration parameters of the new cloud computing system/cloud provider be input and the existing historical datasets be input for the training data to be generated and the AIOps model 570 retrained. It should be appreciated that this retraining of the AIOps model 570 using existing historical datasets and the learned causal model is less costly than retraining that requires actual launching of the application and collection of monitoring data over days of execution. Data collection is not required to perform the retraining as it uses existing historical datasets of monitoring data already previously collected. Thus, the costs are minimized to the costs of the actual machine learning training of the AIOps model 570 itself and avoiding costs of launching the application and collecting monitoring data.

In cases where retraining of the AIOps model 570 is not feasible, the causal model learned by the mechanisms of the illustrative embodiments may be used to fine tune the hidden nodes H of the causal layer without changing the parameters of the AIOps model 570. In this embodiment, the updated AIOps model 570 is actually a combination of the original AIOps model 570, or source AIOps model, and the fine-tuned causal layer 554, i.e., the hidden nodes of the causal layer 554. In this embodiment, the cloud computing system/cloud provider configuration parameters 552 and a few minutes of monitoring data 556 collected from the monitors 542 monitoring the execution of the application 530 launched in the new cloud computing system/cloud provider environment 540, are used to fine tune the hidden nodes of the causal layer 554. In this embodiment, the fine-tuned causal layer 554 acts as an embedding layer for the AIOps model 570. Thus, later collected monitoring data 556 is processed via the fine-tuned causal layer 554 which modifies the monitoring data 556 according to the embeddings and generates modified input data that is input to the AIOps model 570, which is not modified itself.

Thus, through the offline phase operation of the AIOps model adaptation system 300 a causal model is generated and its parameters learned through chaos engineering, such that the causal model may be used to adapt an AIOps model for operation in a new cloud computing system/cloud provider. In some illustrative embodiments, the learned causal model may be used to generate training data from existing historical monitoring data of the new cloud computing system/cloud provider and then retrain the AIOps model. In some illustrative embodiments, the learned causal model may be used to adapt monitoring data collected to fine tune the causal model to provide an embedding of the monitoring data for input to an unmodified AIOps model. In either illustrative embodiment, the application does not need to be relaunched on a new cloud computing system/cloud provider to adapt the AIOps model. Thus, the costs of retraining of an AIOps model after relaunching the application and collecting multiple days of monitoring data are avoided.

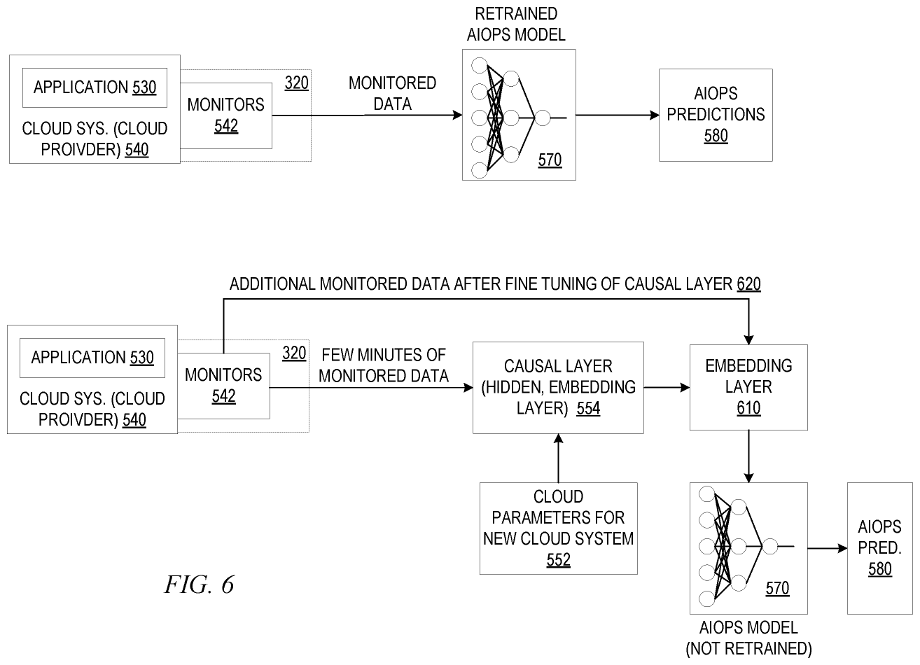

During an online phase of operation, the AIOPs model adaptation system 300 operates to respond to the MCC or other application broker, requesting an update to the AIOps model, such as in response to a migration of an application from one cloud computing system/cloud provider to another. FIG. 6 is an example diagram illustrating an online phase of operation of an AIOps model adaptation system in accordance with one illustrative embodiment. The operation shown in FIG. 6 assumes that a multi-cloud controller (MCC) 310 or other application broker triggers the application migration from one cloud computing system/cloud provider to another and informs the observability tool of this migration, as described previously with regard to FIG. 3. The observability tool 320 requests an update of the AIOps model from the AIOps model adaptation system 300. Depending on whether retraining of the AIOps model 570 was performed during offline phase operations, or fine tuning of the causal layer was performed rather than retraining, the online operation of the causal generative model 550 operates differently.

In one illustrative embodiment, where the AIOps model 570 has been retrained using the learned causal layer 554 of the causal generative model 550, then the monitoring data may be input to the AIOps model 570 from the monitors 542 of the observability tool which operates on them to generate AIOps predictions 580, as the AIOps model 570 has already been adapted during the offline phase to correspond to the application 530 executing in the new cloud computing system/cloud provider 540. Again, the retraining is done during an offline phase of operation prior to online migration of the application to the new cloud computing system/cloud provider and without having to launch the application and collect monitoring data. Rather, existing historical monitoring data is used along with the learned causal layer to generate new training data and retrain the AIOps model 570 during offline operation so that when online migration occurs, the AIOps model 570 is already retrained for operation directly on the monitoring data collected from the monitors 542.

In a second illustrative embodiment, in which retraining of the AIOps model 570 is not performed, as shown in FIG. 6, the online phase involves launching the application 530 in the new cloud computing system/cloud provider 540 and collecting a small amount of monitoring data 556, e.g., a few minutes of monitoring data 556. In addition, the configuration parameters for the new cloud computing system/cloud provider 540 are input to the causal generative model 550. This allows the fine tuning of the causal layer 554 to the application 530 execution in the new cloud computing system/cloud provider 540 using the previously learned causal layer 554 mapping of configuration parameters to monitoring data. The fine-tuned causal layer 554 may then be used as an embedding layer for newly acquired monitoring data 556 such that the newly acquired monitoring data 556 from the monitors 542 may be passed through the embedding layer 610. The embedding layer 610 is a projection of the monitoring data 620 which is input to the existing AIOps model 570 to generate AIOps predictions 580.

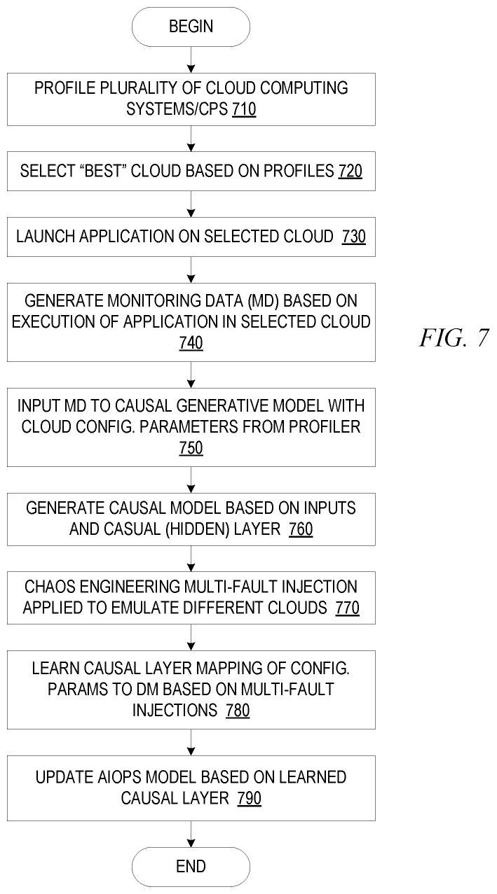

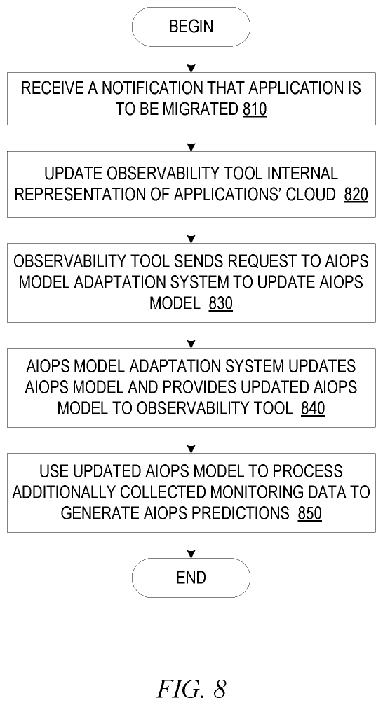

FIGS. 7-8 present flowcharts outlining example operations of elements of the present invention with regard to one or more illustrative embodiments. It should be appreciated that the operations outlined in FIGS. 7-8 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 7-8, and may, in some cases, make use of the results generated as a consequence of the operations set forth in FIGS. 7-8, the operations in FIGS. 7-8 themselves are specifically performed by the improved computing tool in an automated manner.

FIG. 7 is a flowchart outlining an example offline operation of an AIOps model adaptation system in accordance with one illustrative embodiment. As shown in FIG. 7, the operation starts by profiling a plurality of cloud computing systems/cloud providers (step 710) and selecting a “best” cloud computing system/cloud provider based on the generated profiles (step 720). The application is launched on the selected cloud computing system/cloud provider (step 730) and monitors generate monitoring data based on observing the execution of the application in the selected cloud computing system/cloud provider (step 740). The monitoring data is input to a causal generative model along with cloud computing system/cloud provider configuration parameters from the profiler for the selected cloud computing system/cloud provider (step 750). A causal model is generated based on these inputs and a causal layer comprising hidden nodes between infra nodes and monitoring data nodes (step 760). Chaos engineering multi-fault injection is then applied to emulate different cloud computing systems/providers by perturbing configuration parameters (step 770). The causal layer mapping from the configuration parameters to the monitoring data is learned based on the multi-fault injections for various perturbed configuration parameters (step 780). The learned causal layer is then used to update the AIOps model (step 790) and the operation terminates. In some illustrative embodiments, the updating of the AIOps model may involve a retraining of the AIOps model based on existing historical monitoring data and the learned causal layer. In other illustrative embodiments, the updating of the AIOps model may involve fine tuning the causal layer by collecting a few minutes of monitoring data from the launched application in the new cloud computing system/cloud provider and then using the fine-tuned causal layer as an embedding layer for additional monitoring data prior to input to the AIOps model.

FIG. 8 is a flowchart outlining an example online operation of an AIOps model adaptation system in accordance with one illustrative embodiment. As shown in FIG. 8, the operation starts by receiving a notification, e.g., Inform( ) call to the migration API of the observability tool, that an application is to be migrated (step 810). The internal representation of the application's corresponding cloud computing system topology is updated in the observability tool based on a mapping data structure obtained from the multi-cloud controller (step 820). The observability tool sends a request to the AIOps model adaptation system to update the AIOps model (step 830). The AIOps model adaptation system updates the AIOps model and provides the updated AIOps model back to the observability tool (step 840). The updating of the AIOps model may be performed in different ways depending on what was performed in the offline phase of operation. In some illustrative embodiments, where the AIOps model is retrained using the existing historical monitoring data and the learned causal layer, the retrained AIOps model is provided as the updated AIOps model to the observability tool. In some illustrative embodiments in which retraining is not performed, the updated AIOps model is a combination of the fine-tuned causal layer, now acting as an embedding layer for the original AIOps model which is also provided as part of the updated AIOps model. The updated AIOps model is then used to process the additionally collected monitoring data by the observability tool to generate AIOps predictions (step 850). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for migrating an application to a new cloud computing system, comprising:
generating a causal model based on configuration parameters for a first cloud computing system, monitoring data collected for an execution of the application in the first cloud computing system, and an inserted causal layer;
executing chaos engineering logic on the causal model to perform a fault injection on the configuration parameters to emulate at least one second cloud computing system configuration;
learning a mapping, by the causal layer, of the configuration parameters to the monitoring data based on the fault injection by the chaos engineering logic;
updating an artificial intelligence for information technology operations (AIOps) model, based on the learned mapping of the causal layer, to be an updated AIOps model for monitoring the application execution in the new cloud computing system; and
providing the updated AIOps model to an observability tool executing on the new cloud computing system for use in monitoring the performance of the application in the new cloud computing system.

2. The method of claim 1, wherein the method is triggered by a migration of an application associated with the AIOps model from the first cloud computing system to the new cloud computing system.

3. The method of claim 2, wherein the migration of the application is triggered by a multi-cloud controller based on at least one of a user request to migrate the application, a determination that the migration of the application results in a cost savings, or the multi-cloud controller detecting a fault in the first cloud computing system.

4. The method of claim 2, wherein in response to a multi-cloud controller (MCC) initiating the migration of the application, informing, by the MCC, the observability tool of a mapping of elements of the first cloud computing system to elements of the cloud computing system, and updating, in the observability tool, elements for the application based on the mapping.

5. The method of claim 1, further comprising generating, by the causal model, a training dataset, from existing historical data already present and associated with the new cloud computing system, based on the learned mapping of the causal layer, and wherein updating the AIOps model comprises retraining the AIOps model based on the generated training dataset.

6. The method of claim 1, wherein updating the AIOps model comprises implementing the causal layer as an embedding layer for inputs to the AIOps model to modify inputs based on the embedding layer prior to input to the AIOps model.

7. The method of claim 1, further comprising monitoring performance of the application in the new cloud computing system based on the updated AIOps model.

8. A computer program product comprising a computer readable storage medium having a computer readable program stored therein, wherein the computer readable program, when executed on a data processing system, causes the data processing system to perform the process comprising:
generating a causal model based on configuration parameters for a first cloud computing system, monitoring data collected for an execution of the application in the first cloud computing system, and an inserted causal layer;
executing chaos engineering logic on the causal model to perform a fault injection on the configuration parameters to emulate at least one second cloud computing system configuration;
learning a mapping, by the causal layer, of the configuration parameters to the monitoring data based on the fault injection by the chaos engineering logic;
updating an artificial intelligence for information technology operations (AIOps) model, based on the learned mapping of the causal layer, to be an updated AIOps model for monitoring the application execution in the new cloud computing system; and
providing the updated AIOps model to an observability tool executing on the new cloud computing system for use in monitoring the performance of the application in the new cloud computing system.

9. The computer program product of claim 8, wherein the process is triggered by a migration of an application associated with the AIOps model from the first cloud computing system to the new cloud computing system.

10. The computer program product of claim 9, wherein the migration of the application is triggered by a multi-cloud controller based on at least one of a user request to migrate the application, a determination that the migration of the application results in a cost savings, or the multi-cloud controller detecting a fault in the first cloud computing system.

11. The computer program product of claim 9, wherein in response to a multi-cloud controller (MCC) initiating the migration of the application, informing, by the MCC, the observability tool of a mapping of elements of the first cloud computing system to elements of the cloud computing system, and updating, in the observability tool, elements for the application based on the mapping.

12. The computer program product of claim 8, further comprising generating, by the causal model, a training dataset, from existing historical data already present and associated with the new cloud computing system, based on the learned mapping of the causal layer, and wherein updating the AIOps model comprises retraining the AIOps model based on the generated training dataset.

13. The computer program product of claim 8, wherein updating the AIOps model comprises implementing the causal layer as an embedding layer for inputs to the AIOps model to modify inputs based on the embedding layer prior to input to the AIOps model.

14. The computer program product of claim 8, further comprising monitoring performance of the application in the new cloud computing system based on the updated AIOps model.

15. An apparatus comprising:
at least one processor; and
at least one memory coupled to the at least one processor, wherein the at least one memory comprises instructions which, when executed by the at least one processor, cause the at least one processor to perform the process comprising:
generating a causal model based on configuration parameters for a first cloud computing system, monitoring data collected for an execution of the application in the first cloud computing system, and an inserted causal layer;
executing chaos engineering logic on the causal model to perform a fault injection on the configuration parameters to emulate at least one second cloud computing system configuration;
learning a mapping, by the causal layer, of the configuration parameters to the monitoring data based on the fault injection by the chaos engineering logic;
updating an artificial intelligence for information technology operations (AIOps) model, based on the learned mapping of the causal layer, to be an updated AIOps model for monitoring the application execution in the new cloud computing system; and
providing the updated AIOps model to an observability tool executing on the new cloud computing system for use in monitoring the performance of the application in the new cloud computing system.

16. The apparatus of claim 15, wherein the process is triggered by a migration of an application associated with the AIOps model from the first cloud computing system to the new cloud computing system.

17. The apparatus of claim 16, wherein the migration of the application is triggered by a multi-cloud controller based on at least one of a user request to migrate the application, a determination that the migration of the application results in a cost savings, or the multi-cloud controller detecting a fault in the first cloud computing system.

18. The apparatus of claim 16, wherein in response to a multi-cloud controller (MCC) initiating the migration of the application, informing, by the MCC, the observability tool of a mapping of elements of the first cloud computing system to elements of the cloud computing system, and updating, in the observability tool, elements for the application based on the mapping.

19. The apparatus of claim 15, further comprising generating, by the causal model, a training dataset, from existing historical data already present and associated with the new cloud computing system, based on the learned mapping of the causal layer, and wherein updating the AIOps model comprises retraining the AIOps model based on the generated training dataset.

20. The apparatus of claim 15, wherein updating the AIOps model comprises implementing the causal layer as an embedding layer for inputs to the AIOps model to modify inputs based on the embedding layer prior to input to the AIOps model.
